(19) United States
(12) Patent Application Publication
(10) Pub. No.: US 2011/0203269 A1
(43) Pub. Date: Aug. 25, 2011

(54) Engine Vacuum System

(75) Inventors: Amey Y. Karnik, Dearborn, MI (US); Michael Joseph Zaitz, Dearborn, MI (US); Julia Helen Buckland, Commerce TWP, MI (US); Ralph Wayne Cunningham, Milan, MI (US)

(73) Assignee: FORD GLOBAL TECHNOLOGIES, LLC, Dearborn, MI (US)

(21) Appl. No.: 13/050,647

(22) Filed: Mar. 17, 2011

(51) Int. Cl. B60T 13/57; F15D 1/00

(52) U.S. Cl. 60/547.1; 137/1

(57) ABSTRACT

A vacuum pump onboard a vehicle provides vacuum for a brake booster and to control the electronic vacuum regulation valve (EVRV) valve of a wastegate on a turbocharger. Commands to the EVRV are based on an operating condition of an engine and the vacuum level in the vacuum system. In one example, a vacuum sensor is provided to determine vacuum proximate the EVRV. In another example, the vacuum proximate the EVRV is modeled based on the vacuum at the brake booster, which may be determined by a vacuum sensor coupled to the brake booster.

### TECHNICAL FIELD

The present disclosure relates to providing vacuum for a vehicle vacuum system and using the vacuum for control and brake assist purposes.

### BACKGROUND

Brake assist systems and turbocharger wastegates are just two examples of devices that may be vacuum operated. The ability to provide brake assist and to control the vacuum operated wastegate as desired depends on there being a sufficient amount of vacuum in the vacuum system as well as knowledge of the vacuum level. However, the level of vacuum within the vacuum system may vary depending on vehicle operating conditions. Therefore, it may be difficult to control vacuum operated devices with a desired level of consistency.

### SUMMARY

The inventors herein have recognized the above disadvantages and have developed a system that can improve vacuum actuator performance. In one example, a vacuum system for a vehicle is provided where the vacuum system includes a vacuum pump; a brake booster in pneumatic communication with the vacuum pump via a check valve; a wastegate valve for a turbocharger in pneumatic communication with the vacuum pump via a vacuum outlet port of an electronic vacuum regulation valve (EVRV); a first vacuum sensor located along a pneumatic passage and in pneumatic communication with a vacuum inlet port of the EVRV; and a controller electronically coupled to the vacuum sensor and the EVRV.

By placing an EVRV in a pneumatic passage (e.g., a conduit or duct) in pneumatic communication with a vacuum operated turbocharger wastegate, it may be possible to operate the turbocharger wastegate in a consistent manner even when the vacuum level in the vacuum system varies. For example, a wastegate controller command can be modified in response to a vacuum level within the vacuum system (e.g., a vacuum level at a vacuum inlet port of the EVRV) such that a vacuum level at the vacuum outlet port of the EVRV reaches desired vacuum level within a desired time interval. In one example, an EVRV command signal can be over driven (e.g. commanded to a greater vacuum level than the desired vacuum level) so that vacuum at the EVRV outlet port approaches the desired vacuum level in a more timely manner. The EVRV command signal can be reduced such that vacuum at the EVRV vacuum outlet port converges to the desired vacuum level when the EVRV outlet vacuum is near the desired vacuum level.

The present description may provide several advantages. For example, the approach may improve vacuum operated turbocharger wastegate control by allowing the wastegate to approach a desired position at a faster rate. Further, the approach may improve engine fuel economy by reducing the amount of time boost is produced in excess of demanded boost. In this way, engine backpressure may be reduced so that engine pumping work is reduced, thereby lowering fuel consumption. The approach may also provide for improved engine emissions since the wastegate position control may follow the wastegate demand position closer than other vacuum operated systems. Internal engine and external engine EGR flow rates may be closer to desired EGR flow rates so as to reduce NOx emissions when the wastegate demand is more closely followed.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic representation of the vacuum system as applied to an engine system;

FIG. 2 is a chart describing a model to estimate reservoir vacuum;

FIG. 3 is a prophetic plot of an example comparison between actual and estimated vacuum levels at a vacuum inlet port of an EVRV;

FIG. 4 is a representation of a lead-lag filter to model reservoir vacuum based on brake booster vacuum;

FIG. 5 is a chart showing an example for determining and commanding duty cycle to the EVRV; and

FIG. 6 is a chart showing an example for determining and commanding vacuum pump speed.

### DETAILED DESCRIPTION

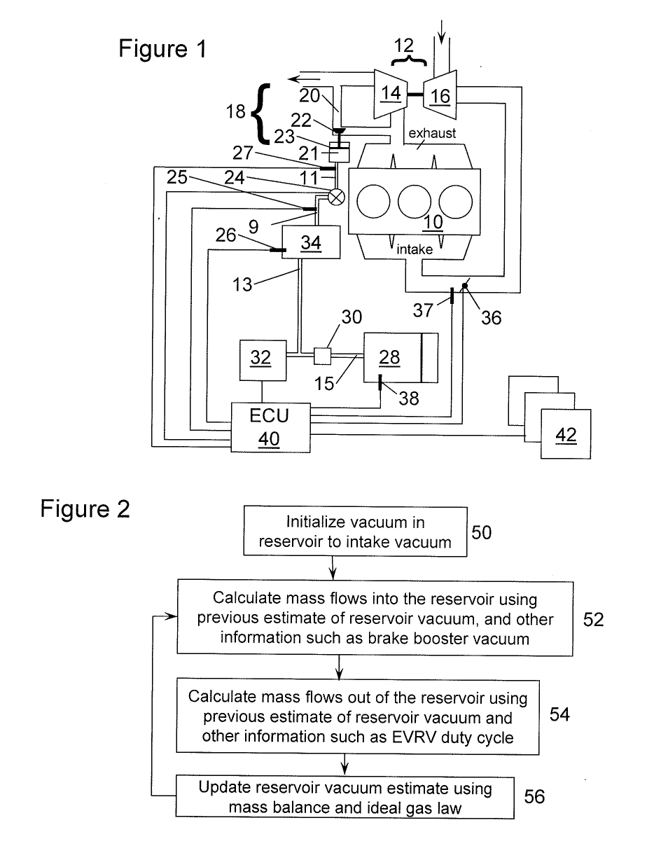

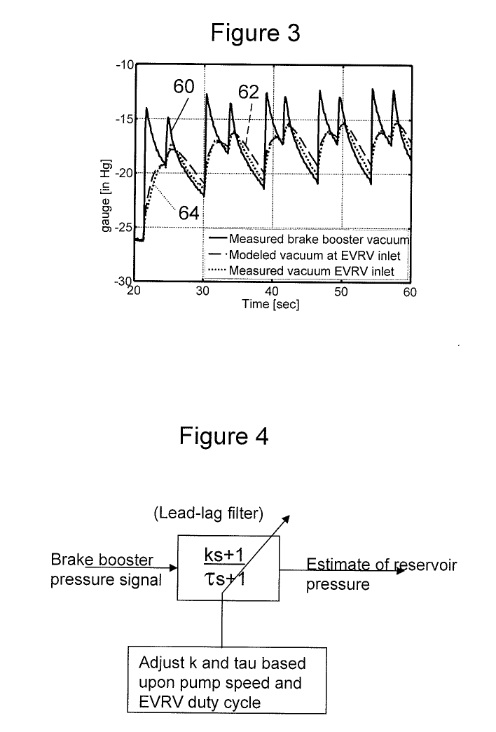

The present description is related to controlling a wastegate of a turbocharged engine. FIG. 1 shows one example of a boosted engine where the methods of FIGS. 2, 4, 5 and 6 may be applied. FIG. 3 shows a comparison of actual and estimated vacuum levels at a vacuum inlet port of an EVRV when a vacuum level at a brake booster in pneumatic communication with the EVRV changes. FIGS. 2, 4, 5, and 6 show example flowcharts for operating a vacuum operated turbocharger wastegate.

A vacuum pump can be provided onboard a vehicle for brake assist and for vacuum controlled valves, such as to control a wastegate coupled to a turbocharger. Rather than provide a vacuum pump for each device, one vacuum pump can be provided. It is useful for the vacuum level at the vacuum inlet port of the vacuum-operated valves to be known so that the valves can be controlled to a desired position or setting. Further, by knowing the vacuum level at the inlet port of the vacuum-operated valve, it is possible to estimate the position of the wastegate during conditions of low vacuum at the vacuum source. The vacuum level at the vacuum inlet port of a vacuum operated valve can be inferred based on actuation of the various vacuum operated devices. Further, signals from system sensors, such as vacuum sensors, located in the vacuum system at locations that are remote from the vacuum operated valve being controlled may be useful to determine a vacuum level at a vacuum inlet port of the vacuum operated valve being controlled.

Referring now to FIG. 1, an internal combustion engine 10 having a turbocharger 12 for pressurizing or boosting charging intake air is shown. Turbocharger 12 includes an exhaust turbine 14 that is shaft coupled to a compressor 16. A wastegate 18 may divert exhaust gases around turbine 14 such that exhaust gases bypass the turbine. The speed of turbine 14 may be regulated by diverting exhaust gases around turbine 14, thereby regulating the rotational speed of compressor 16. One function of wastegate 18 is to regulate the boost pressure so as to limit the cylinder air charge of engine 10 and the speed of turbocharger 12. Wastegate 18 includes a passage 20 that bypasses turbine 14 and a wastegate valve 22. Wastegate valve 22 may control the amount of exhaust gas flow that is allowed to bypass turbine 14. A position of wastegate valve 22 is modified when vacuum in wastegate vacuum reservoir 21 acts on diaphragm 23. A vacuum level in wastegate vacuum reservoir 21 may be adjusted via an electronic vacuum regulation valve (EVRV) 24. A vacuum inlet port of EVRV 24 is in pneumatic communication with wastegate vacuum reservoir 21 and wastegate 18 via vacuum passage 11. Vacuum passage 11 may be a conduit or duct. Alternatively, vacuum passage may be internal to wastegate 18 and wastegate vacuum reservoir 21 may be mechanically coupled to or integrated into turbocharger 12. In one example, wastegate valve 22 is mechanically coupled to wastegate vacuum reservoir 21 via diaphragm 23. In one example, the vacuum level at the vacuum outlet port of EVRV 24 is based on a duty cycle of a signal provided to EVRV 24 via controller 40. Vacuum acts on one side of diaphragm 23 in wastegate valve 22 and ambient pressure on the other side; the force balance between the vacuum and spring force determines the position of wastegate valve 22. It should also be noted that pressure in the engine exhaust may also affect the position of the wastegate valve.

Also shown in FIG. 1 is a brake booster 28 that provides brake assist to the brake force applied to the brake pedal (not shown) by a vehicle operator. A check valve 30 is provided between the vacuum source, a vacuum pump 32 in the example in FIG. 1, and brake booster 28. Check valve 30 allows the vacuum level in brake booster 28 to be retained in brake booster 28 even when the level of vacuum on the other side of check valve 30 is reduced below the vacuum level in brake booster 28. Vacuum passage 15 allows pneumatic communication between brake booster 28 and check valve 30. In one example, vacuum passage 15 is a conduit or duct. Vacuum pump 32 provides vacuum for both EVRV 22 and brake booster 28. In some examples, a vacuum reservoir 34 is positioned along a vacuum passage (e.g., a conduit or duct) and between wastegate 18 and brake booster 28. Vacuum reservoir 34 is provided to increase vacuum reserve capacity and to dampen vacuum fluctuations. In the present example, vacuum reservoir 34 is positioned between vacuum passages 9 and 13. Vacuum passages 9 and 13 may be in the form of a conduit or duct, in some examples.

In one example, a vacuum sensor 25 is provided in the line or passage 9 between a vacuum inlet port of EVRV 24 and reservoir 34. In an alternative example, a vacuum sensor 26 is provided in reservoir 34 or alternatively, the line or passage 13 between reservoir 34 and vacuum pump 32. In yet another alternative, a vacuum sensor 27 is provided in the line or passage 11 between a vacuum outlet port of EVRV 24 and wastegate vacuum reservoir 21. Due to the cost of sensors, it is possible that only one of vacuum sensors 25, 26, and 27 would be provided in the vacuum system. Vacuum sensor 25 provides greater measurement accuracy of the vacuum level available at the vacuum inlet port of EVRV 24 than the more remote location of sensor 26. However, sensor 26 provides greater accuracy concerning the vacuum capacity of the vacuum system than sensor 25. Vacuum sensor 27 provides an indication of the vacuum level at the vacuum outlet port of EVRV 24 so as to provide desirable information in a feedback control system where the vacuum commanded EVRV outlet port vacuum may be corrected according to the actual EVRV outlet port vacuum as observed via vacuum sensor 27. In other examples, as described in more detail below, neither of vacuum sensors 25, 26, or 27 are included and the vacuum is modeled with other sensor signals being inputs to the model.

An electronic control unit (ECU) 40 or controller is electronically coupled to: a vacuum sensor 38 in brake booster 28, vacuum pump 32, a throttle valve 36 in an intake of engine 10, a pressure sensor 37 in the engine intake, EVRV 24, and other sensors and actuators 42. ECU 40 may obtain signals from vacuum sensor 38, a speed signal from vacuum pump 32, signals from engine 10, and other sensors 42. ECU 40 can command vacuum pump 32, throttle valve 36, a duty cycle to EVRV 24, and other actuators 42.

An advantage of the arrangement shown in FIG. 1 is that a single vacuum pump provides vacuum for both EVRV 24 and brake booster 28 obviating the need for two vacuum sources. As the two systems are coupled together, it facilitates limiting the number of vacuum sensors for control and diagnostic purposes. In particular, an estimate of vacuum available to supply the vacuum inlet port of EVRV 22 may be estimated from sensors in the vacuum system positioned at locations other than the vacuum inlet port of EVRV 22. Vacuum sensor 38 coupled to brake booster 28 is separated from EVRV 22 by check valve 30 and reservoir 34.

While examples have been illustrated and described, it is not intended that these examples illustrate and describe all possible forms of the description. Rather, the words used in the specification are words of description rather than limitation, and it is understood that various changes may be made without departing from the spirit and scope of the description.

Thus, the system of FIG. 1 provides for a vacuum system, comprising: a vacuum pump; a brake booster in pneumatic communication with the vacuum pump via a check valve; a wastegate valve for a turbocharger in pneumatic communication with the vacuum pump via a vacuum outlet port of an electronic vacuum regulation valve (EVRV); a first vacuum sensor; and a controller electronically coupled to the first vacuum sensor and the EVRV. Thus, the first vacuum sensor may be located in a vacuum passage leading to the vacuum inlet port of the EVRV or the first vacuum sensor may be located in a vacuum passage leading to the vacuum outlet port of the EVRV.

In one example, the vacuum further comprises a vacuum reservoir located along a pneumatic passage, the pneumatic passage allowing pneumatic communication between a vacuum inlet port of the EVRV and the vacuum pump, where the vacuum reservoir is separate from the brake booster, and where the first vacuum sensor is located along a pneumatic passage and in pneumatic communication with the vacuum inlet port of the EVRV. The vacuum system includes where the first vacuum sensor is positioned along the pneumatic passage between the vacuum inlet port of the EVRV and the vacuum reservoir. The vacuum system includes where the first vacuum sensor is positioned in one of: the vacuum reservoir, the brake booster, and between the vacuum reservoir and the vacuum pump. The vacuum system further comprises a second vacuum sensor mechanically coupled to the brake booster and electronically coupled to the controller.

In another example, the vacuum system further comprises instructions for the controller to command a vacuum output of the EVRV in response to at least one of the first vacuum sensor and the second vacuum sensor. The vacuum system includes where the vacuum system is part of a vehicle that also includes an internal combustion engine to which the turbocharger is coupled and to which the controller is electronically coupled, and instructions for the controller to command a vacuum level at the vacuum outlet port of the EVRV in response to an engine operating condition.

Thus, the system of FIG. 1 provides for a vacuum system for an automobile, comprising: a vacuum pump; a brake booster, the brake booster in pneumatic communication with the vacuum pump via a check valve; a wastegate valve for a turbocharger, the wastegate in pneumatic communication with the vacuum pump via a vacuum outlet port of an electronic vacuum regulation valve (EVRV); a first vacuum sensor; and an electronic control unit (ECU) electronically coupled to the first vacuum sensor and the EVRV, and where the ECU includes instructions for estimating vacuum at a vacuum inlet port of the EVRV in response to a signal from the first vacuum sensor. The vacuum system includes where the automobile has an internal combustion engine with a turbocharger, the turbocharger has a turbine and a wastegate valve that is located along a bypass duct that allows pneumatic communication between an inlet and an outlet of the turbine, and where the vacuum outlet port of the EVRV is in pneumatic communication with the wastegate valve so that the EVRV controls a position of the wastegate valve, where the first vacuum sensor is located along a second pneumatic passage allowing pneumatic communication between the vacuum outlet port of the EVRV and the wastegate valve. In this way, the EVRV may be controlled to provide a desired level of vacuum to the wastegate actuator to thereby control the turbocharger wastegate.

The vacuum system also includes where the first vacuum sensor is located along a pneumatic passage allowing pneumatic communication between the brake booster and the check valve, and further comprising a second vacuum sensor located along a second pneumatic passage allowing pneumatic communication between the vacuum outlet port of the EVRV and the wastegate valve. In one example, the vacuum system further comprises a vacuum reservoir located along a pneumatic passage allowing pneumatic communication between the vacuum pump and the vacuum inlet port of the EVRV, the vacuum reservoir located between the vacuum pump and the vacuum inlet port of the EVRV, and where the ECU includes further instructions for estimating a vacuum level at the vacuum inlet port of the EVRV in response to at least one of the signal from the vacuum sensor, volume of the vacuum reservoir, and volume of other vacuum system vacuum holding components, the first vacuum sensor located along a pneumatic passage allowing pneumatic communication between the brake booster and the check valve. The vacuum system includes where the automobile includes an internal combustion engine to which a turbocharger is coupled and to which the ECU is electronically coupled; and the ECU including further instructions for commanding the vacuum level at the vacuum inlet port of the EVRV via adjusting a speed of the vacuum pump in response to an engine operating condition.

In some examples, the vacuum system includes where the vacuum level at the vacuum inlet port of the EVRV is modeled with at least one of system volumes, system flow restrictions, vacuum pump speed, and a duty cycle commanded to the EVRV. The vacuum also includes where the vacuum level at the vacuum inlet port of the EVRV is modeled with a lead-lag filter. The vacuum system further includes where the lead-lag filter has calibration coefficients based on vacuum pump effectiveness, volumes of in the vacuum system, orifice sizes of system valves, and flow resistances in the vacuum system; and the calibration coefficients are functions of rotational speed of the vacuum pump.

In one example of FIG. 2, no such vacuum sensors such as 25, 26, and 27 are provided. In particular, a model is executed to estimate vacuum available at the vacuum inlet port of EVRV 24. The model may be executed via computer instructions by controller 40 of FIG. 1.

At 50, the pressure in the vacuum reservoir is initialized to engine air intake pressure. In one example, engine air intake pressure is determined from a pressure sensor (e.g., pressure sensor 37 of FIG. 1). The air mass flows into and out of the vacuum reservoir are estimated based on known information such as the last known vacuum level in the vacuum reservoir and any other signal information, such as brake booster vacuum level and EVRV duty cycle, e.g., position of EVRV in blocks 52 and 54. During some operating conditions, the vacuum level of vacuum reservoir 34 may be determined directly from the vacuum level of brake booster 28. Based on the updates to 52 and 54, a new vacuum reservoir vacuum level is estimated using mass balance and the ideal gas law in 56. The new value of reservoir vacuum level is fed back to block 52 and 54. As data are available in block 50, block 50 can be executed to obtain a fresh value of reservoir vacuum. Per the example illustrated in FIG. 2, vacuum can be estimated based on brake booster pressure utilizing the ideal gas law and invoking a mass balance. No additional vacuum sensor is employed.

Referring now to FIG. 3, a prophetic plot of an example comparison between actual and estimated vacuum levels at a vacuum inlet port of an EVRV is shown. In one example, the plot of FIG. 3 is based on a vacuum system as described in FIG. 1. The Y axis represents gauge pressure in inches of mercury. Negative values indicate vacuum and pressure of zero represents atmospheric pressure. Thus, vacuum increases in the direction of increasing negative numbers on the Y axis. The X axis represents time, and time increases from the left to right. Curve 60 represents vacuum at a brake booster. Curve 62 represents estimated vacuum at a vacuum inlet port of an EVRV where the estimated vacuum is based on vacuum at the brake booster (e.g., curve 60). Curve 64 represents actual vacuum as measured at the vacuum inlet port of the EVRV.

During the first few seconds, the vacuum in the brake booster is substantially constant at 26 in Hg vacuum, indicating a large vacuum level. The brake pedal is repeatedly actuated and released during the time period between 22 seconds and 60 seconds. The vacuum level decreases when the brake is applied, and the vacuum level decreases again when the brake pedal is released. During the time between applying brakes and releasing brakes, vacuum in the brake booster increases since the vacuum pump may be continuously supplying vacuum to the vacuum system. For example, at 22 seconds the brake pedal is depressed applying vehicle brakes. The vacuum level in the brake booster decreases accordingly. Vacuum increases between 22 and 25 seconds as the vacuum pump evacuates air from the brake booster. The brake pedal is released at about 25 second causing the vacuum level to decrease. The vacuum pump evacuates air from the brake booster during the time period from 25 seconds to 30 seconds, thereby increasing the vacuum level in the brake booster. The brake application and release sequence is repeated from 30 seconds to 60 seconds.

The actual or measured vacuum 64 at the vacuum inlet port of the EVRV also decreases when the brake pedal is applied and released between 22 seconds and 30 seconds. Further, vacuum at the vacuum inlet port of the EVRV increases between the time the brakes are applied and released since the vacuum pump is in pneumatic communication with the vacuum reservoir and the inlet port of the EVRV. However, the vacuum level of the measured vacuum 64 is different than the vacuum level at the brake booster 60. The differences between vacuum at the brake booster and vacuum at the vacuum inlet port of the EVRV may be related to the distance between the measurement positions, the volume of the vacuum reservoir, vacuum pump operation, and the structure of the vacuum system (e.g., vacuum passage lengths and volumes, check valves, and other physical characteristics). The noticeable differences between the brake booster pressure and the vacuum inlet port pressure of the EVRV are that the vacuum decreases slower at the vacuum inlet port of the EVRV as compared to the vacuum in the brake booster when the brake is applied or released. Further, the vacuum level increases faster at the inlet port of the EVRV.

The vacuum modeled at the vacuum inlet port 62 of the EVRV closely follows the measured vacuum 64 at the vacuum inlet port of the EVRV. In one example, the model is comprised of a lead-lag filter that has brake booster vacuum as an input to the model. Thus, it can be observed that the output of the model (e.g., curve 62) may be substituted for a vacuum measurement at the vacuum inlet of the EVRV. In this way, vacuum at the vacuum inlet port of the EVRV may be modeled in the absence of a vacuum sensor at the vacuum inlet port of the EVRV so as to reduce the number of sensors in the vacuum system.

Referring now to FIG. 4, a dynamic filter is employed to estimate the vacuum in the reservoir. The lead-lag filter of FIG. 4 may be used as part of the method of FIG. 2 to determine vacuum reservoir vacuum or vacuum at the vacuum inlet port of EVRV 24 of FIG. 1.

A lead-lag filter with two calibration parameters, k and tau, can be used to approximate the vacuum at the vacuum inlet port of the EVRV. Alternatively, a lead-lag filter may be used to estimate vacuum in a vacuum reservoir at a location remote from the brake booster. The two calibration parameters may depend on the vacuum pump effectiveness, volumes of the reservoir and system lines, orifice sizes of system valves, and flow resistances in the system. Thus, by adjusting the filter calibration coefficients, output of the model can be adjusted to represent different conditions in the vacuum system. Furthermore, in some examples, the calibration coefficients may be functions of the vacuum pump rotational speed. Where the model estimates vacuum in a vacuum reservoir, the vacuum in the vacuum reservoir can be used to determine vacuum at the vacuum inlet port of the EVRV and to determine vacuum capacity of the vacuum system. The example illustrated in FIG. 4 models reservoir vacuum based on brake booster vacuum, e.g., no additional sensor required.

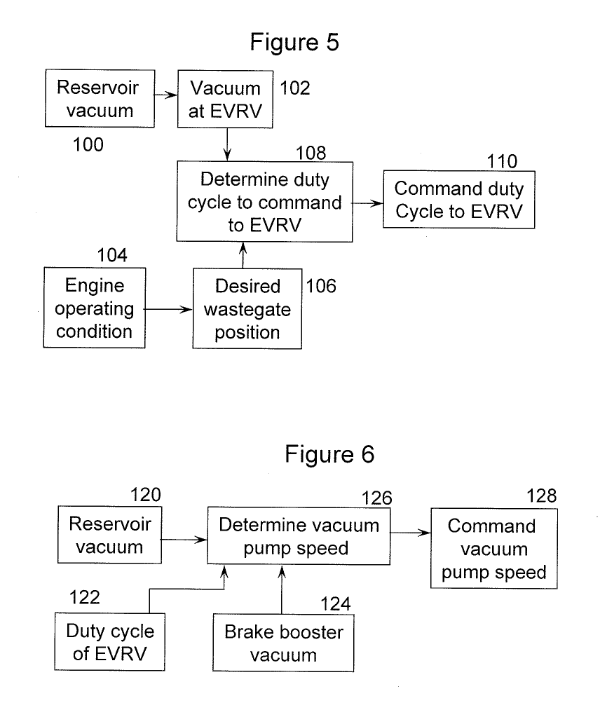

In FIG. 5, one example method to determine EVRV duty cycle is shown. The method of FIG. 5 is executable via instructions residing in a controller such as ECU 40 of FIG. 1.

A vacuum level at the vacuum reservoir is determined in block 100, either by direct measurement or by either of the modeling approaches described above. A vacuum level at the vacuum inlet port of the EVRV is determined at 102. In one example, the vacuum level of the vacuum reservoir is input into a filter such as the filter described in FIG. 4 to estimate the vacuum level at the vacuum inlet port of the EVRV.

At 104, engine operating conditions, such as engine speed, engine torque, engine coolant and oil temperatures, vacuums upstream and downstream of the exhaust turbine and compressor, variable turbocharger setting, exhaust gas recirculation conditions, etc. are inputs to the method of FIG. 5. A desired wastegate position is determined at 106 from engine operating conditions. In one example, engine speed and requested engine torque are index variables to a table that contains empirically determined wastegate positions. The table is indexed according to the present engine speed and present engine torque demand and a desired wastegate position is output from the table of calculations. In other examples, different and/or additional variables may be used to index tables having more than two dimensions. For example, wastegate position may be further adjusted in response to barometric pressure. As such, a three dimensional table may be indexed via engine speed, torque demand, and barometric pressure to output a desired wastegate position.

At 108, the EVRV duty cycle command is determined in response to vacuum at the vacuum input port of the EVRV and the desired wastegate position. In one example, a two dimensional table is indexed via the desired wastegate position and the vacuum at the vacuum input port. The table outputs an empirically determined duty cycle command that is based on the vacuum at the vacuum input port of the EVRV and the desired wastegate position. In this way, operation of the EVRV can be adjusted in an open-loop manner. In some examples, the output of the table may be filtered so that the duty cycle changes at a predictable rate. Further, in some examples where a vacuum sensor is available at the vacuum outlet of the EVRV, vacuum information from the vacuum sensor may be used as data indicative of wastegate position so that the commanded EVRV duty cycle may be feedback corrected. For example, according to the system of FIG. 1, data from vacuum sensor 27 may be passed through a transfer function that relates vacuum in wastegate reservoir 21 to a position of wastegate valve 22. The wastegate position estimated from vacuum in wastegate reservoir 21 is subtracted from the desired wastegate position of 106 to provide a wastegate position error. The wastegate position error may be multiplied by a wastegate position error gain term and then added to the EVRV duty cycle command. In some examples, the wastegate position error gain term may be proportional to the magnitude of the wastegate position error. In some examples, an integral action could be used in addition to the proportional correction. In this way, errors in the position of the wastegate valve may be corrected in a closed loop fashion.

It should also be noted that the wastegate position error gain term may be non-linear so as to provide a duty cycle representative of an increased amount of vacuum when the wastegate position error is greater than a threshold level. If the wastegate position error approaches zero the gain may be made small. In this way, the wastegate duty cycle can be overdriven so as to move the wastegate quickly toward the desired wastegate position. In some examples, where the EVRV includes an internal regulator for reaching the commanded vacuum at the EVRV outlet, the wastegate position error gain term can be used to reduce the amount of time to reach the commanded vacuum. For example, the wastegate position error gain term may be calibrated such that a large gain is provided until the actual vacuum at the vacuum outlet port of the EVRV is close to the desired vacuum at the vacuum outlet port. The wastegate position error gain term may then be reduced so that the actual vacuum at the vacuum outlet port of the EVRV converges to and does not over shoot the desired vacuum at the vacuum outlet port.

It should be noted that the methods and systems described herein may be implemented on a basis of pressure rather than vacuum if desired. As such, these implementations are also within the scope of the description.

At 110, the duty cycle is commanded to the EVRV. The duty cycle is commanded via sending instructions to hardware that outputs a duty cycle signal to the EVRV. In some examples, the EVRV duty cycle may be near battery voltage while in other examples the EVRV duty cycle may be at logic voltage levels. The method of FIG. 5 exits after the EVRV duty cycle is output.

Referring now to FIG. 6, one example method for controlling a vacuum pump is shown. The method of FIG. 6 is executable via instructions residing in a controller such as ECU 40 of FIG. 1.

At 120, a vacuum level in vacuum reservoir may be either modeled or based on a signal from a vacuum sensor positioned at the reservoir. In one example, the methods of FIGS. 2 and 4 are used to determine a vacuum level at the vacuum reservoir 34 of FIG. 1.

At 122, a duty cycle of the EVRV is determined. The EVRV duty cycle may be determined via reading a memory location of a controller or via being passed a variable from 108 of the method of FIG. 5.

At 124, brake booster vacuum is determined. In one example, brake booster vacuum is determined from an output of a vacuum sensor positioned at the brake booster. In other examples, brake booster vacuum may be inferred from brake pedal position, vacuum pump speed, and atmospheric pressure.

At 126, vacuum pump speed is determined from vacuum reservoir vacuum, EVRV duty cycle, and brake booster vacuum. In particular, the vacuum pump speed is determined from a function that relates vacuum pump speed to an air flow rate out of the vacuum pump, and air flow out of the vacuum pump is determined from the air flow rate into the vacuum system (e.g., air flow into the vacuum system may be determined from EVRV duty cycle and brake booster air flow) and vacuum in the vacuum reservoir. Additionally, vacuum pump speed may be feedback controlled via a vacuum signal from vacuum sensor 26 of FIG. 1. If a vacuum level of the vacuum reservoir is less than a desired vacuum level, vacuum pump speed may be increased. If a vacuum level of the vacuum reservoir is greater than a desired vacuum level, the vacuum pump speed may be decreased or the vacuum pump may be deactivated.

At 128, the method of FIG. 6 commands the vacuum pump speed. In one example, the vacuum pump speed may be controlled via increasing a voltage supplied to the vacuum pump. In another example, vacuum pump speed may be controlled via providing a higher rate of electric commutation to the vacuum pump. The method of FIG. 6 exits after the vacuum pump speed is commanded.

Thus, the methods of FIGS. 2, 5, and 6 provide for a method to control a turbocharger wastegate valve in an automobile that has a vacuum system for brake assist and controlling the turbocharger wastegate valve, comprising: adjusting a duty cycle of a signal supplied to an EVRV in response to a vacuum at an EVRV vacuum port and a desired wastegate position. By adjusting the EVRV based on a vacuum level at a vacuum port of the EVRV it is possible to control the wastegate via the EVRV. The method includes where a vacuum level at the EVRV vacuum port is based on a signal from a vacuum sensor located along a pneumatic passage, the pneumatic passage allowing pneumatic communication between the EVRV vacuum port and a vacuum pump, the vacuum sensor located between the EVRV vacuum port and the vacuum pump, and where the vacuum system includes the vacuum pump, a brake booster in pneumatic communication with the vacuum pump via a check valve, and an EVRV vacuum outlet port in pneumatic communication with the turbocharger wastegate valve and the vacuum pump. The method also includes where the vacuum level at the EVRV vacuum port is based on an output of a vacuum sensor, and where the vacuum system further comprises a vacuum reservoir located along a vacuum passage that allows pneumatic communication between the EVRV vacuum port and the vacuum pump, and where the vacuum sensor is located in one of: in the vacuum reservoir; in a passage allowing pneumatic communication between the vacuum reservoir and the EVRV vacuum port; between the EVRV vacuum outlet port and the wastegate; and between the vacuum reservoir and the vacuum pump. The method also includes where the vacuum system is provided on an automobile in which an exhaust turbine is coupled to an internal-combustion engine, the turbocharger wastegate valve is disposed in a duct that bypasses exhaust around the exhaust turbine, and the desired wastegate position is based at least on a present engine operating condition. The method further includes where the EVRV vacuum port is an EVRV outlet vacuum port.

As will be appreciated by one of ordinary skill in the art, the methods described in FIGS. 2, 4, 5 and 6 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps, methods, or functions may be repeatedly performed depending on the particular strategy being used.

As those of ordinary skill in the art will understand, various features of the examples illustrated and described with reference to any one of the Figures may be combined with features illustrated in one or more other Figures to produce alternative examples that are not explicitly illustrated and described. The combinations of features illustrated provide representative examples for typical applications. However, various combinations and modifications of the features consistent with the teachings of the present disclosure may be desired for particular applications or implementations. Those of ordinary skill in the art may recognize similar applications or implementations consistent with the present disclosure, e.g., ones in which components or processes are arranged in a slightly different order than shown in the examples in the Figures. Those of ordinary skill in the art will recognize that the teachings of the present disclosure may be applied to other applications or implementations.

While the best mode has been described in detail, those familiar with the art will recognize various alternative designs and examples within the scope of the following claims. Where one or more examples have been described as providing advantages or being preferred over other examples and/or over prior art in regard to one or more desired characteristics, one of ordinary skill in the art will recognize that compromises may be made among various features to achieve desired system attributes, which may depend on the specific application or implementation. These attributes include, but are not limited to: cost, strength, durability, life cycle cost, marketability, appearance, packaging, size, serviceability, weight, manufacturability, ease of assembly, etc. The examples described as being less desirable relative to other examples with respect to one or more characteristics are not outside the scope of the disclosure as claimed.

This concludes the description. The reading of it by those skilled in the art would bring to mind many alterations and modifications without departing from the spirit and the scope of the description. For example, single cylinder, I2, I3, I4, I5, V6, V8, V10, V12 and V16 engines operating in natural gas, gasoline, diesel, or alternative fuel configurations could use the present description to advantage.

What is claimed is:

1. A vacuum system, comprising:
a vacuum pump;
a brake booster in pneumatic communication with the vacuum pump via a check valve;
a wastegate valve for a turbocharger in pneumatic communication with the vacuum pump via a vacuum outlet port of an electronic vacuum regulation valve (EVRV);
a first vacuum sensor; and
a controller electronically coupled to the first vacuum sensor and the EVRV.

2. The vacuum system of claim 1, further comprising a vacuum reservoir located along a pneumatic passage, the pneumatic passage allowing pneumatic communication between a vacuum inlet port of the EVRV and the vacuum pump, where the vacuum reservoir is separate from the brake booster, and where the first vacuum sensor is located along a pneumatic passage and in pneumatic communication with the vacuum inlet port of the EVRV.

3. The vacuum system of claim 2, where the first vacuum sensor is positioned along the pneumatic passage between the vacuum inlet port of the EVRV and the vacuum reservoir.

4. The vacuum system of claim 2, where the first vacuum sensor is positioned in one of: the vacuum reservoir, the brake booster, and between the vacuum reservoir and the vacuum pump.

5. The vacuum system of claim 1, further comprising a second vacuum sensor mechanically coupled to the brake booster and electronically coupled to the controller.

6. The vacuum system of claim 5, further comprising instructions for the controller to command a vacuum output of the EVRV in response to at least one of the first vacuum sensor and the second vacuum sensor.

7. The vacuum system of claim 5, where the vacuum system is part of a vehicle that also includes an internal combustion engine to which the turbocharger is coupled and to which the controller is electronically coupled, and instructions for the controller to command a vacuum level at the vacuum outlet port of the EVRV in response to an engine operating condition.

8. A vacuum system for an automobile, comprising:
a vacuum pump;
a brake booster, the brake booster in pneumatic communication with the vacuum pump via a check valve;
a wastegate valve for a turbocharger, the wastegate in pneumatic communication with the vacuum pump via a vacuum outlet port of an electronic vacuum regulation valve (EVRV);
a first vacuum sensor; and
an electronic control unit (ECU) electronically coupled to the first vacuum sensor and the EVRV, and where the ECU includes instructions for estimating vacuum at a vacuum inlet port of the EVRV in response to a signal from the first vacuum sensor.

9. The vacuum system of claim 8, where the automobile has an internal combustion engine with a turbocharger, the turbocharger has a turbine and a wastegate valve that is located along a bypass duct that allows pneumatic communication between an inlet and an outlet of the turbine, and where the vacuum outlet port of the EVRV is in pneumatic communication with the wastegate valve so that the EVRV controls a position of the wastegate valve, where the first vacuum sensor is located along a second pneumatic passage allowing pneumatic communication between the vacuum outlet port of the EVRV and the wastegate valve.

10. The vacuum system of claim 8, where the first vacuum sensor is located along a pneumatic passage allowing pneumatic communication between the brake booster and the check valve, and further comprising a second vacuum sensor located along a second pneumatic passage allowing pneumatic communication between the vacuum outlet port of the EVRV and the wastegate valve.

11. The vacuum system of claim 8, further comprising a vacuum reservoir located along a pneumatic passage allowing pneumatic communication between the vacuum pump and the vacuum inlet port of the EVRV, the vacuum reservoir located between the vacuum pump and the vacuum inlet port of the EVRV, and where the ECU includes further instructions for estimating a vacuum level at the vacuum inlet port of the EVRV in response to at least one of the signal from the vacuum sensor, volume of the vacuum reservoir, and volume of other vacuum system vacuum holding components, the first vacuum sensor located along a pneumatic passage allowing pneumatic communication between the brake booster and the check valve.

12. The vacuum system of claim 11, where the automobile includes an internal combustion engine to which a turbocharger is coupled and to which the ECU is electronically coupled; and the ECU including further instructions for commanding the vacuum level at the vacuum inlet port of the EVRV via adjusting a speed of the vacuum pump in response to an engine operating condition.

13. The vacuum system of claim 11, where the vacuum level at the vacuum inlet port of the EVRV is modeled with at least one of system volumes, system flow restrictions, vacuum pump speed, and a duty cycle commanded to the EVRV.

14. The vacuum system of claim 11, where the vacuum level at the vacuum inlet port of the EVRV is modeled with a lead-lag filter.

15. The vacuum system of claim 14, where the lead-lag filter has calibration coefficients based on vacuum pump effectiveness, volumes of in the vacuum system, orifice sizes of system valves, and flow resistances in the vacuum system; and the calibration coefficients are functions of rotational speed of the vacuum pump.

16. A method to control a turbocharger wastegate valve in an automobile that has a vacuum system for brake assist and controlling the turbocharger wastegate valve, comprising:
adjusting a duty cycle of a signal supplied to an EVRV in response to a vacuum at an EVRV vacuum port and a desired wastegate position.

17. The method of claim 16, where a vacuum level at the EVRV vacuum port is based on a signal from a vacuum sensor located along a pneumatic passage, the pneumatic passage allowing pneumatic communication between the EVRV vacuum port and a vacuum pump, the vacuum sensor located between the EVRV vacuum port and the vacuum pump, and where the vacuum system includes the vacuum pump, a brake booster in pneumatic communication with the vacuum pump via a check valve, and an EVRV vacuum outlet port in pneumatic communication with the turbocharger wastegate valve and the vacuum pump.

18. The method of claim 17, where the vacuum level at the EVRV vacuum port is based on an output of a vacuum sensor, and where the vacuum system further comprises a vacuum reservoir located along a vacuum passage that allows pneumatic communication between the EVRV vacuum port and the vacuum pump, and where the vacuum sensor is located in one of:
in the vacuum reservoir;
in a passage allowing pneumatic communication between the vacuum reservoir and the EVRV vacuum port;
between the EVRV vacuum outlet port and the wastegate; and
between the vacuum reservoir and the vacuum pump.

19. The method of claim 16, where the vacuum system is provided on an automobile in which an exhaust turbine is coupled to an internal-combustion engine, the turbocharger wastegate valve is disposed in a duct that bypasses exhaust around the exhaust turbine, and the desired wastegate position is based at least on a present engine operating condition.

20. The method of claim 19, where the EVRV vacuum port is an EVRV outlet vacuum port.
